(19) United States
(12) Patent Application Publication
(10) Pub. No.: US 2008/0029435 A1
(43) Pub. Date: Feb. 7, 2008

(54) Rejuvenation process for olefin polymerization and alkylation catalyst

(75) Inventors: Benjamin S. Umansky, Fairfax, VA (US); Ajit B. Dandekar, Bridgewater, NJ (US); Tomas R. Melli, Haymarket, VA (US); Amanda K. Miller, Rancho Palos Verdes, CA (US); Ronald D. McGihon, Chantilly, VA (US)

Correspondence Address: ExxonMobil Research & Engineering Company, P.O. Box 900, 1545 Route 22 East, Annandale, NJ, 08801-0900, US

(73) Assignee: ExxonMobil Research and Engineering Company, Annandale, NJ (US)

(21) Appl. No.: 11/812,484

(22) Filed: Jun. 19, 2007

Related U.S. Application Data
(60) Provisional application No. 60/834,805, filed on Aug. 2, 2006.

(51) Int. Cl. C10G 35/04; B01J 38/04

(52) U.S. Cl. 208/134; 502/34

(57) ABSTRACT

A method of rejuvenating a deactivated molecular sieve catalyst, deactivated by use in an olefin oligomerization or aromatics alkylation process, which method comprises contacting the deactivated catalyst with a stream of rejuvenation gas comprising a hydrocarbon product fraction from the process at an elevated temperature and pressure for a time sufficient to effect an increase in catalytic activity of the deactivated catalyst.

### CROSS REFERENCE TO RELATED APPLICATIONS

The present application claims priority from U.S. Provisional Application Ser. No. 60/834,805.

The present application is related to the following previously filed applications which describe related catalytic processes used for making gasoline boiling range liquid hydrocarbon products:
U.S. Ser. No. 11/362257, filed 27 Feb. 2006, “Gasoline Production by Olefin Polymerization”.
U.S. Ser. No. 11/362,139, filed 27 Feb. 2006, “Gasoline Production By Olefin Polymerization With Aromatics Alkylation”
U.S. Ser. No. 11/362,256, filed 27 Feb. 2006, “Process for Making High Octane Gasoline with Reduced Benzene Content”
U.S. Ser. No. 11/362,255, filed 27 Feb. 2006, “Vapor Phase Aromatics Alkylation Process”
U.S. Ser. No. 11/362,139, filed 27 Feb. 2006, “Liquid Phase Aromatics Alkylation Process”

The present rejuvenation process is intended for use with manufacturing processes such as those described in these previous applications; accordingly, reference is made to these prior application for details of the processes and of the equipment used for carrying them out.

The present application is also related to concurrently filed application Ser. No. ______ which claims priority from Provisional Application Ser. No. 60/834,804, entitled “Olefin Upgrading Process with Guard Bed Regeneration”.

### FIELD OF THE INVENTION

This invention relates to a method for the rejuvenation of solid, molecular sieve catalysts used in light olefin polymerization and alkylation processes for the production of gasoline boiling range motor fuel.

### BACKGROUND OF THE INVENTION

As described in the earlier applications to which reference is made above, the introduction of catalytic cracking processes in petroleum refining in the early 1930s, resulted in large amounts of olefins, particularly light olefins such as ethylene, propylene, butylene, becoming available in copious quantities from the new catalytic cracking plants in refineries. While these olefins may be used as petrochemical feedstock, many conventional petroleum refineries producing petroleum fuels and lubricants are not capable of diverting these materials to petrochemical uses. Processes for producing fuels from these cracking off gases are therefore desirable and from the early days, a number of different processes evolved. The early thermal polymerization process was rapidly displaced by the superior catalytic processes of which there was a number. The first catalytic polymerization process used a sulfuric acid catalyst to polymerize isobutene selectively to dimers which could then be hydrogenated to produce a branched chain octane for blending into aviation fuels. Other processes polymerized isobutylene with normal butylene to form a co-dimer which again results in a high octane, branched chain product. An alternative process uses phosphoric acid as the catalyst, on a solid support and this process can be operated to convert all the C₃ and C₄ olefins into high octane rating, branched chain polymers. This process may also operate with a C₄ olefin feed so as to selectively convert only isobutene or both n-butene and isobutene. This process has the advantage over the sulfuric acid process in that propylene may be polymerized as well as the butenes and at the present time, the solid phosphoric acid [SPA] polymerization process or Polygas™ process remains the most important refinery polymerization process for the production of motor gasoline.

In the SPA polymerization process, feeds are pretreated to remove hydrogen sulfide and mercaptans which would otherwise enter the product and be unacceptable, both from the view point of the effect on octane and upon the ability of the product to conform to environmental regulations. Typically, a feed is washed with caustic to remove hydrogen sulfide and mercaptans, after which it is washed with water to remove organic bases and any caustic carryover. Because oxygen promotes the deposition of tarry materials on the catalyst, both the feed and wash water are maintained at a low oxygen level. Additional pre-treatments may also be used, depending upon the presence of various contaminants in the feeds. With the most common solid phosphoric acid catalyst, namely phosphoric acid on kieselguhr, the water content of the feed needs to be controlled carefully because if the water content is too high, the catalyst softens and the reactor may plug. Conversely, if the feed is too dry, coke tends to deposit on the catalyst, reducing its activity and increasing the pressure drop across the reactor. As noted by Henckstebeck, the distribution of water between the catalyst and the reactants is a function of temperature and pressure which vary from unit to unit, and for this reason different water concentrations are required in the feeds to different units. Petroleum Processing Principles And Applications, R. J. Hencksterbeck McGraw-Hill, 1959. As described in the prior applications cited above, there are two general types of units used for the SPA process, based on the reactor type, the unit may be classified as having chamber reactors or tubular reactors. The chamber reactor contains a series of catalyst beds with bed volume increasing from the inlet to the outlet of the reactor, with the most common commercial design having five beds. The catalyst load distribution is designed to control the heat of conversion.

For the production of motor gasoline only butene and lighter olefins are employed as feeds to polymerization processes as heavier olefins up to about C₁₀ or C₁₁ can be directly incorporated into the gasoline. With the SPA process, propylene and butylene are satisfactory feedstocks and ethylene may also be included, to produce a copolymer product in the gasoline boiling range. Limited amounts of butadiene may be permissible although this diolefin is undesirable because of its tendency to produce higher molecular weight polymers and to accelerate deposition of coke on the catalyst. The process generally operates under relatively mild conditions, typically between 150° and 200° C., usually at the lower end of this range between 150° and 180° C., when all butenes are polymerized. Higher temperatures may be used when propylene is included in the feed. In a well established commercial SPA polymerization process, the olefin feed together with paraffinic diluent, is fed to the reactor after being preheated by exchange with the reaction effluent.

The solid phosphoric acid catalyst used is non-corrosive, which permits extensive use of carbon steel throughout the unit. The highest octane product is obtained by using a butene feed, with a product octane rating of [R+M]/2 of 89 to 91 being typical. With a mixed propylene/butene feed, product octane is typically about 91 and with propylene as the primary feed component, product octane drops to typically 87.

In spite of the advantages of the SPA polymerization process, which have resulted in over 200 units being built since 1935 for the production of gasoline fuel, a number of disadvantages are encountered, mainly from the nature of the catalyst. Although the catalyst is non-corrosive, so that much of the equipment may be made of carbon steel, it does lead it to a number of drawbacks in operation. First, the catalyst life is relatively short as a result of pellet disintegration which causes an increase in the reactor pressure drop. Second, the spent catalyst encounters difficulties in handling from the environmental point of view, being acidic in nature. Third, operational and quality constraints limit flexible feedstock utilization. Obviously, a catalyst which did not have these disadvantages would offer considerable operating and economic advantages.

In application Ser. No. 11/362257, we have described the production of gasoline boiling range hydrocarbons by a process using solid, non-corrosive molecular sieve catalysts to polymerize (oligomerize) light olefins in a refinery stream such as FCC off-gas; this process can be operated in an existing Polygas unit with relatively minor unit modifications and so, given the advantages of the molecular sieve catalysts, the new process offers and economically attractive way of improving existing refinery units for gasoline production. A related aromatics alkylation process is described in Ser. Nos. 11/362,256, 11/362,255 and 11/362,139; in the process set out in these applications, a gasoline boiling range product of low benzene content is produced using light refinery olefins to alkylate reformate streams containing significant levels of benzene. Application Ser. No. 11/362,139 describes a number of integrated process schemes which combine the polymerization process with the benzene alkylation process. Further information about this process is given in NPRA Paper No. 05-77, ExxonMobil Olefins to Gasoline, EMOGAS™ Technology, Chitnis et al.

One operational problem with molecular sieve catalysts is that that the useful life of a catalyst is limited. The active sites of the catalyst may be poisoned by contaminants in the feedstock such as oxygen-, nitrogen-, and sulphur-containing compounds or the sites may become blocked by the build-up of unwanted by-products of reaction, usually the carbonaceous material often referred to as “coke”. It has been found that certain upstream processes in the petrochemical industry form nitrites that are deleterious to catalyst activity; certain sulphur-containing compounds are deleterious, especially those which require a high temperature to be desorbed from the sieve. The carbonaceous deposits (“coke”), typically of a high molecular weight, block not only the active sites on the surface of the molecular sieve, but also the pores of the catalyst matrix, preventing access of reactants to active internal sites.

A spent catalyst may be discarded, but disposal may be economically or environmentally unacceptable. A catalyst may be regenerated, by which term is meant the restoration of the activity of the catalyst to or very near to its original activity. The most common regeneration technique, oxidative regeneration, however, requires high temperatures and it the reactor metallurgy is inconsistent with these temperatures, the catalyst will need to be removed from the reactor, often to a remote location, with the difficulty of dealing with a prolonged reactor downtime and often substantial expense. An alternative is catalyst rejuvenation, by which is meant increasing the activity of a deactivated (a term used to include partly deactivated) catalyst, but not necessarily to its original activity. Rejuvenation methods may be carried out more easily than regeneration, resulting in decreased reactor downtime, and in some cases may be carried out in the reactor itself.

A number of catalyst rejuvenation methods using liquid treating agents have been previously proposed in connection with other processes. U.S. Pat. No. 4,550,090, for example, describes the regeneration of a deactivated ZSM-5 dewaxing catalyst, including the removal of nitrogenous contaminants, by treatment of the catalyst with a base, e.g., NH₄OH, and solvent-extraction. WO 01/80995 describes rejuvenating a crystalline molecular sieve, especially a SAPO or AlPO₄ type catalyst, deactivated by moisture, by treatment with an anhydrous liquid or vapour.

Other rejuvenation methods have used treatment with heated gas streams to effect a restoration of catalytic activity. U.S. Pat. No. 5,059,738, for example, describes the reactivation of a methanol-to-gasoline conversion catalyst using a stream of inert purge gas such as nitrogen, a light paraffinic hydrocarbon or a Group VIII gas (inert gases, Group 18, new table notation) of the Periodic Table. The deposit of hydrocarbon or “coke” formed on the catalysts in the methanol-to-hydrocarbon conversion processes, such as the methanol-to-olefins (MTO) process and the methanol-to-gasoline (MTG) process, is known to result from alkylation and dealkylation reaction steps involving aromatic intermediates and for this reason, the coke formed in these processes contains significant amounts of monocyclic or polycyclic (up to 4 or 5 ring) aromatics. When the process uses a large pore open structure molecular sieve as catalyst, such as ZSM-5, the single ring aromatics are sufficiently small to escape from the catalyst and appear in the product.

U.S. Pat No. 4,417,086 describes a fluidized bed oligomerization process in which the flow of feed into the reaction zone may be periodically stopped and the product may continue to be stripped from the catalyst with a stripping gas, which may be nitrogen. The oligomerization feed is made up of gaseous olefins and the oligomerization is operated with the olefin feedstock in the gas phase. The activity in such a gas phase oligomerization, which typically operates at a higher temperature, typically above 300° C., as compared to the dense phase processes described in the related applications, is significantly lower. In the dense phase olefin oligomerization processes (feedstock partially or entirely in the liquid phase or in the supercritical condition) typically operate at temperatures of not more than 300° C. and the carbonaceous deposits formed under these conditions are predominantly non-aromatic with a hydrogen to carbon atom ratio typically between 1.6 and 2.0. The same holds true for the processes for making low benzene fuels by alkylation of an aromatic feedstock, usually reformate, with a light olefin as alkylating agent. The operating temperatures of these processes are typically similar to those of liquid or dense phase oligomerization when the olefinic alkylating agent is ethylene, and even lower when the olefinic alkylating agent is propylene or a normal butene such as butene-1 or butene-2.

Other processes involving inert gas stripping of a catalyst have also been proposed. EP-A-716 887, for example, describes reactivating a solid acid catalyst, in particular a solid phosphoric acid catalyst, in situ by subjecting it to sub-atmospheric pressure, removal of material released by this means optionally being assisted by introducing an inert gas, e.g., nitrogen, into the reactor while evacuating. In a number of other prior proposals, e.g., EP-A-1 070 694 and U.S. Pat. No. 4,560,536, nitrogen is used to purge a catalyst bed before regeneration or rejuvenation, for example by burning with oxygen or solvent-extraction.

The contact with nitrogen, however, is not shown to be adequate in itself, i.e., without the necessity of any other treatment, to effect rejuvenation. Indeed, from the conditions of contact with nitrogen disclosed (for example, the low partial pressure inherent in the procedure mentioned in EP-A-716 887 and the scavenging conditions of the other two references) when compared with the intensity of the treatments that follow, it seems unlikely that any significant reaction was to take place between the nitrogen and the catalyst as such. In addition, it is necessary to take into account the affinities which may exist between the catalyst material and the deactivating contaminants, so that different catalytic materials may be expected to behave differently under similar stripping regimes.

### SUMMARY OF THE INVENTION

The light olefin conversion process described in the earlier applications uses a solid, particulate catalyst which is non-corrosive, which is stable in fixed bed operation, which exhibits the capability of extended cycle duration before regeneration is necessary and which can be readily handled and which can be finally disposed of simply and economically without encountering significant environmental problems. This catalyst therefore commends itself as a “drop in” replacement for the solid phosphoric acid catalyst used in the SPA catalytic condensation process for the production of motor fuels. A light olefin refinery stream such as ethylene, propylene, optionally with butylene and possibly other light olefins, is polymerized to form a gasoline boiling range [C₅+−200° C.][C₅+−400° F.] product in the presence of a zeolite catalyst, preferably a zeolite of the MWW family of zeolites, a family which includes zeolites PSH 3, MCM-22, MCM-49, MCM-56, SSZ 25, ERB-1 and ITQ-1. As a variant to the process a benzene-containing aromatic stream such as a reformate may be used as a co-feed to produce a gasoline product containing a reduced quantity of benzene which, during the process is converted to high octane alkylaromatics such as toluene.

According to the present invention, the catalyst used is rejuvenated by the use of a product stream from the process. Suitably, this stream may comprise a stream of product from the process from which the light feed olefins have essentially been removed by the processing, whether by simple polymerization or by alkylation of aromatics in an aromatic co-feed when this is used. The product stream may be recovered from the product fractionator. As an alternative, a stream of nitrogen or other olefin-free gas may be used although this is not so economically favorable as the direct use of the product stream as described below.

### DRAWINGS

FIG. 1 shows a process schematic for the olefin polymerization unit for converting light refinery olefins to motor gasoline with a circuit for catalyst rejuvenation.

FIGS. 2 and 3 are graphs showing the effect of catalyst rejuvenation.

### DETAILED DESCRIPTION

The present process is for the conversion of light cracking olefins or the alkylation of aromatics by light cracking olefins to produce higher boiling liquid hydrocarbon products, for example, motor gasoline and other motor fuels such as road diesel blend stock as well as alkylaromatic petrochemical products such as ethylbenzene and cumene. For convenience, the present guard bed regeneration technique will be described below with reference to the olefin polymerization process and the aromatics alkylation processes described in the earlier filed applications cited above but its is more generally applicable, to other similar processes using molecular sieve catalysts and requiring a guard bed to remove contaminants form the feed stream which would otherwise deactivate the catalyst. As described in our previous applications, the olefin conversion process when used to produce gasoline boiling range product, is intended to provide a replacement for the SPA polymerization process, using a molecular sieve catalyst which can be used as a direct replacement for SPA and so enables existing SPA units to be used directly with the new catalyst, so allowing the advantages of the new catalyst and process to be utilized while retaining the economic benefit of existing refinery equipment. The aromatic alkylation process is similar in operation and again, is used to convert light refinery olefins to higher value, higher boiling liquid products.

As described in prior applications, Ser. Nos. 11/362257 and 11/362,139, the gasoline boiling range products can be produced by the polymerization (oligomerization) of a light refinery olefin stream. An alternative to the straightforward polymerization process is an aromatics alkylation process of the type described in Ser. Nos. 11/362,256, 11/362,255, 11/362,139, which may be combined with the polymerization process as described in Ser. No. 11/362,139. Reference is made to these prior applications for descriptions of the basic olefin upgrading processes.

The present guard bed regeneration technique is, as noted, capable of use with other processes using molecular sieve catalysts which are subject to poisoning by contaminants in the feed, including processes for converting olefins into lubricants as described in U.S. Pat. No. 4,956,514 which describes the use of zeolite MCM-22 as an olefin oligomerization catalyst for making lube range materials by the oligomerization of low molecular weight olefins such as propylene and FCC off gas streams. Other processes to which it can be applied are the well-established processes for manufacturing aromatics such as ethylbenzene or cumene, using reactions such as alkylation and transalkylation. The cumene production (alkylation) process is described in U.S. Pat. No. 4,992,606 (Kushnerick et al). Ethylbenzene production processes are described in U.S. Pat. No. 3,751,504 (Keown); U.S. Pat. No. 4,547,605 (Kresge); and U.S. Pat. No. 4,016,218 (Haag); U.S. Pat. Nos. 4,962,256; 4,992,606; 4,954,663; 5,001,295; and 5,043,501 describe alkylation of aromatic compounds with various alkylating agents over catalysts comprising MWW zeolites such as PSH-3 or MCM-22. U.S. Pat. No. 5,334,795 describes the liquid phase synthesis of ethylbenzene with MCM-22. The processes for cumene and ethylbenzene manufacture are well-established commercially and are available under license from vendors such as ExxonMobil Chemical Company and Polimeri Europa.

In their application to the production of hydrocarbon fuels by the processes described in the earlier filed applications, the present olefin upgrading processes utilize light refinery olefins, especially propylene and butane but also ethylene to produce gasoline boiling range liquid hydrocarbon products. When the olefinic refinery stream is used by itself as the sole feed, the product is essentially a light hydrocarbon stream of high octane rating resulting from a high level of branched-chain mono-olefins in the product, principally di-branched octenes. If an aromatic stream such as a reformate is used as a co-feed, the product will be of alkylaroamatic character with the benzene content of the aromatic feed converted to alkylaromatics by reaction of the olefins with benzene and other aromatics from the aromatic feed. In each case, however, the catalyst used in the olefin upgrading process is a solid, porous molecular sieve material. The preferred catalysts are the MWW zeolites such as the MCM-22 family of zeolites (MCM-22, MCM-49, MCM-56) but in certain applications such as the vapor phase olefin/aromatic alkylation process described in U.S. Ser. No. 11/362,255, filed 27 Feb. 2006, “Vapor Phase Aromatics Alkylation Process”, other catalysts may be used, for example, the intermediate pore size zeolites such as ZSM-5, and ZSM-11. Other molecular sieve catalysts which may be used include those based on zeolite Beta, ZSM-22, ZSM-57 as well as large pore size zeolites such as zeolite Y, USY, in forms such as REY, HY and other zeolites such as ZSM-18 or ZSM-20. Thus, in the operation of the present rejuvenation technique, the product generation will be as described in the earlier applications described above, with feeds, catalysts and processing conditions as described in those applications, to which reference is made for a detailed description of them. A metal hydrogenation/dehydrogenation component on the catalyst may be present with potential benefit to the catalyst rejuvenation. Suitable metals may include nickel, cobalt, possibly promoted with molybdenum, chromium or tungsten, or even a noble metal such as platinum or palladium.

The present catalyst rejuvenation process extends the cycle length of the zeolite catalyst. The rejuvenation process for zeolite requires the addition of a stream with minimum or no olefin content (referred to here as a “substantially non-olefinic” stream) at elevated temperature and pressure. Normally, the temperature for the rejuvenation will be from 50 to 300° C. (about 120 to 570° F., although higher temperatures up to about 350 C (660 F) e.g. 315° C. (600° F.) may be used. In most cases, the rejuvenation temperature will be 100° C. (about 210° F.) or more. Pressures will normally be at least 1000 kPag (145 psig) not normally to exceed 8,000 kPag (1160 psig). The optimal combination of temperature and pressure for any given system of catalyst and feed/product may be found by empirical means since the generation of soft coke on the catalyst surfaces will depend upon the selected feed(s), the particular catalyst and the reactions conditions employed. Higher temperature will tend to drive off contaminants and removal of the contaminants will be favored by lower pressures but operation within the ranges of temperature and pressure described will normally be found to yield satisfactory results.

The rejuvenation medium can be nitrogen or paraffinic streams available in the unit or from elsewhere in the refinery. Streams with high aromatic content such as light, intermediate, or full reformate can also be used as the rejuvenation stream. Descriptions of such aromatic streams can be found, for example, in U.S. Ser. Nos. 11/362,256, 11/362,255, and 11/362,139, all filed 27 Feb. 2006, referred to above.

The duration of the rejuvenation treatment can typically vary from 1 hour to 72 hrs, but typically it lasts from 4 to 24 hrs for a reactor containing about 10,000 kg of zeolite catalyst. The rejuvenation stream can have a LHSV between 0.1 to 7 hr⁻¹, typically between 1 to 3 hr⁻¹.

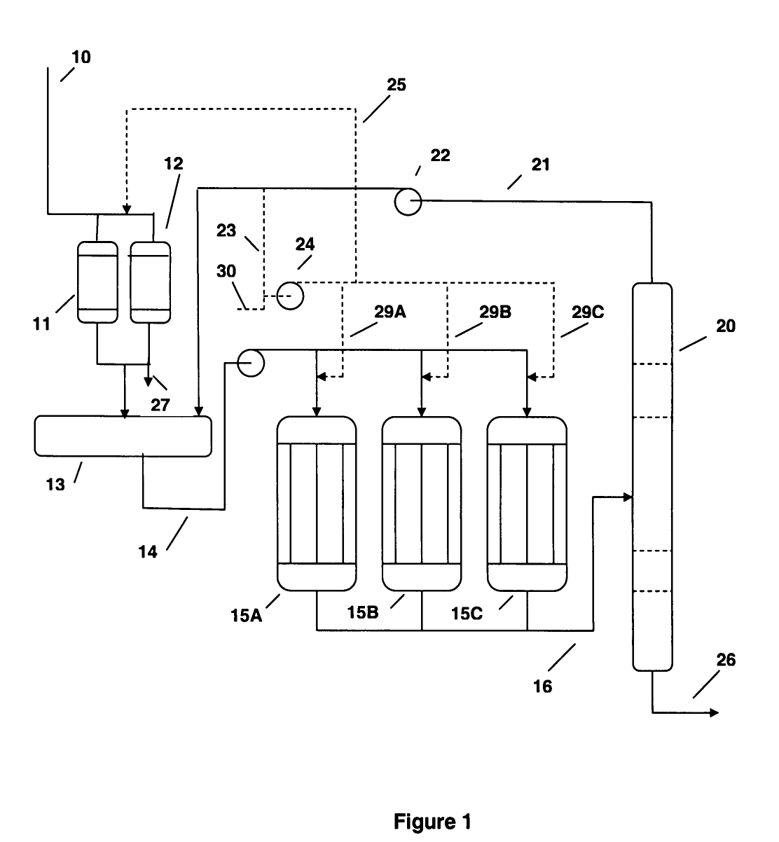

The rejuvenation can be carried out by storing enough of the rejuvenation medium and then passing it through the reactor(s) when catalyst activity is to be restored. If feed storage capacity in the unit is not sufficient for the amount of required rejuvenation feed, the unit can be configured as shown in an illustrative unit configuration in FIG. 1 in which the dotted lines show the needed modifications for a conventional Polygas unit, with the quench circuit omitted for clarity. The reactors can be tubular or chamber type. The number of reactors changes from unit to unit, in this example the configuration has three reactors and this potentially enables the rejuvenation can be practiced in one of the reactors while keeping the others in operation. The feed to be used as the rejuvenation stream is the olefin-depleted stream from the overhead of the fractionation tower. In this configuration, some piping is needed, and an additional pump to boost the recycle stream to the reactor operating pressure; this re-compressor is needed in any event if the recycle is used as quench as described in Ser. No. 11/362257.

FIG. 1 shows an simplified illustrative configuration for an olefin polymerization unit (no aromatic co-feed) which produces a monoolefinic gasoline product (mainly di-branched octenes) by polymerization of the olefins. The scheme shown may however, be used with similar units using an aromatic co-feed to produce alkylaromatic gasoline products. The unit configuration shown is fitted also for regeneration of the guard beds as described in concurrently filed application Serial No. ______, claiming priority from Provisional application Ser. No. 60/834,804, referred to above, entitled “Olefin Upgrading Process with Guard Bed Regeneration”, to which reference is made for a description of the guard bed regeneration technique.

In FIG. 1 the dotted lines show the modifications for a conventional Polygas unit. The reactors can be tubular or chamber type. The number of reactors changes from unit to unit, in this example the configuration has three reactors and this potentially enables the rejuvenation can be practiced in one of the reactors while keeping the others in operation. The feed to be used as the rejuvenation stream is the olefin-depleted stream from the overhead of the fractionation tower. In this configuration, some piping is needed, and an additional pump to boost the recycle stream to the reactor operating pressure; this pump is needed in any event if the recycle is used as quench as described in Ser. No. 11/362257.

A mixed light olefin feed from a catalytic cracking unit is introduced through line 10 and passes through guard bed 11 which operates on a swing reactor system with a matching guard bed 12. The feed then passes to feed drum 13 and on through line 14 to reactors 15A, 15B, 15C. The olefins in the feed are polymerized in reactors 15A, 15B and 15C and effluent from the reactors passes to fractionator 20 by way of manifold line 16. The reactor effluent is fractionated in the fractionator to produce the desired product fractions. The heavy product fraction leaves fractionator 20 through line 23 as product. A portion of the light product fraction together with unreactive paraffins from the feed is removed from the top of the fractionator and passed by way of line 21, pump 22, line 23, pump 24 and line 25 to second guard bed 12 which is in the regeneration phase, desorbing the contaminants which have been removed from the feed. The guard bed vessels are switched alternately between feed treatment and regeneration by means of conventional valving (not shown) which may also direct effluent from the guard bed during the regeneration portion of the cycle to recovery facilities by way of line 27 so as to permit removal of the desorbed contaminants. When desorption of the contaminants from the guard bed in the regeneration phase is complete, the beds can be switched so that bed 11 is in the regeneration phase, receiving product from fractionator 20 to desorb contaminants and bed 12 is put into the feed treatment phase with the feed passing from bed 12 to reactors 15A, 15B and 15C. If the reaction in reactors 15 is the olefin/aromatics alkylation reaction, using a mixed refinery olefin/reformate stream as the feed, the contaminant desorption stream will usually be a light stream with a heavier alkylaromatic fraction going to recovered product.

The guard beds may be operated on the swing cycle with two beds, 11 and 12 as described above. If desired, a purge phase may be added before a regenerated bed is returned to feed treatment although this will not always be necessary since the bed contains at that point only innocuous reaction products which can be recycled to the reaction. A three-bed guard bed system may be used with the two beds used in series for contaminant removal and the third bed on regeneration. With a three guard system used to achieve low contaminant levels by the two-stage series sorption, the beds will pass sequentially through a three-phase cycle of: regeneration, second bed sorption, first bed sorption.

A portion of the light product stream is used as rejuvenation gas for the catalysts in the reactors when rejuvenation is required, at which time, the flow of olefin reactant is stopped and the stream from pump 24 is sent through branch lines 29A, 29B and 29C to reactors 15A, 15B and/or 15C, as necessary, to rejuvenate the catalysts, in accordance with the present invention. Admittance of the rejuvenation stream to the reactors is controlled by appropriate valving of conventional type (not shown). From pump 22, the stream passes to pump 24 before passing on through distributor lines 29A, 29B and/or 29C to the inlets of the three reactors. Reheat may be supplied as necessary to bring the stream up to the requisite temperature for the rejuvenation. If it is desired to carry out the rejuvenation wholly or partly with another stream, e.g. nitrogen, this may be introduced through line 30.

The guard beds may be operated on the swing cycle with two beds, 11 and 12 as described above. If desired, a purge phase may be added before a regenerated bed is returned to feed treatment although this will not always be necessary since the bed contains at that point only innocuous reaction products which can be recycled to the reaction. A three-bed guard bed system may be used with the two beds used in series for contaminant removal and the third bed on regeneration. With a three guard system used to achieve low contaminant levels by the two-stage series sorption, the beds will pass sequentially through a three-phase cycle of: regeneration, second bed sorption, first bed sorption.

Rejuvenation of zeolitic catalyst is performed in-situ, after shutting off the olefinic feed, by means of the stripping action of the light paraffinic stream. The paraffinic stream can be the olefin-depleted LPG quench stream or any other stream containing one or more aliphatic hydrocarbons in the C₁-C₈ range. In the case of the process using an aromatic co-feed, the rejuvenating gas stream may be a light alkylaromatic stream in the C₆ to C₁₀ range such as produced by reaction of benzene with butene. The rejuvenation will normally be performed for a minimum of 1 hr or for a maximum of 3 days, preferentially between 4 to 24 hrs. The rejuvenation process can be performed at pressure between 1000 kPag (145 psig) (or 350 kPag (50 psig) above the stabilizer or feed drum pressure) to 8,000 kPag (1160 psig) preferably between 3,500 to 8,000 kPag (about 510 to 1160 psig) with temperatures from 100 to 310° C. (about 210 to 590° F.), preferentially between 100 and 230° C. (about 210 to 450° F.). The rejuvenation stream can have a LHSV between 0.1 to 7 hr⁻¹, typically between 1 to 3 hr⁻¹.

During the rejuvenation process, some heavy compounds are stripped out from the catalyst, and lowering the reactor pressure will facilitate the removal of these compounds. To utilize these lower pressures the rejuvenation can be performed at a pressure approximately 350 kPa (about 50 psi) above the stabilizer or feed drum pressure. This lower pressure option does not require the additional pump 24 but requires splitting the quench flow and control quench to the feed drum and controlling the rejuvenation stream to the reactor. The outlet of the reactor is blocked in and a line at the reactor outlet(s) installed to one of the following locations: (1) feed drum, (2) stabilizer overhead receiver, or (3) stabilizer feed. Piping to the feed drum is less likely to be disruptive but is the less recommended option. In this low pressure option, procedures would have to be implemented to gradually depressurize and repressurize the reactor so as to avoid perturbing the catalyst bed.

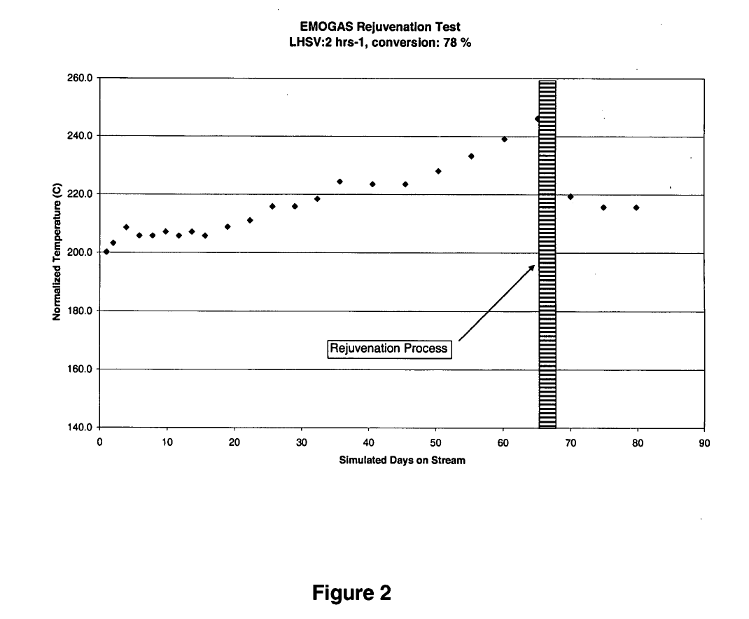

The efficacy of the rejuvenation process is illustrated in FIG. 2, the data for which were obtained in a micro unit fixed bed reactor. In the first run, the selected catalyst was a MCM-22 zeolite catalyst with reduced activity so the effect of the rejuvenation process could be noted during an accelerated deactivation run under typical olefin polymerization conditions. Real refinery LPG feed containing 45% olefins, approximately 2000 ppm dienes and 10 ppm sulfur was used in this experiment. Reactor temperature was adjusted to obtain an olefin conversion of 78%, reactor pressure was maintained at 3800 kPag (550 psig) and an LHSV of 2 hr⁻¹. After the conversion dropped below 25%, the olefinic feed was shut off and catalyst was exposed to nitrogen at 205° C. (400° F.) for 8 hrs. The olefin feed was then reintroduced following this stripping step. Significant recovery in activity is shown in the graph of FIG. 2.

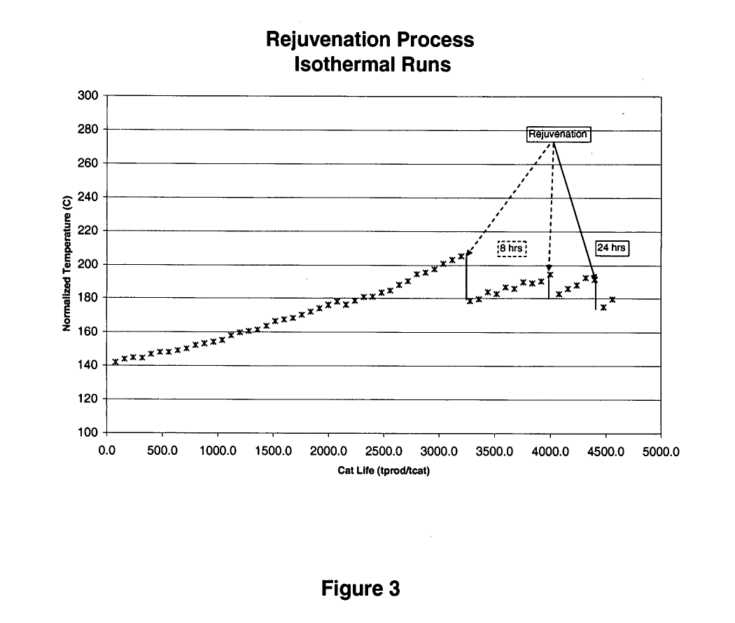

In another experiment, the results of which are illustrated graphically in FIG. 3, the MCM-22 catalyst was tested with the same feed as the previous run. In this case, the feed used for the rejuvenation was a light paraffinic feed containing mainly butane isomers. At around 3300 tonne of product/tonne of catalyst, the paraffinic rejuvenation feed was introduced for around 8 hrs without changing operating conditions. After the initial rejuvenation step, the olefinic refinery feed (LPG) was introduced and around 10 additional days were run without change in the deactivation rate. At this point, another 8 hrs rejuvenation process was performed with an almost identical result to the first one. To test the effect of additional timing, the rejuvenation process was repeated but this time for 24 hrs. The additional time reduced slightly the reactor temperature to get the 78% conversion.

1. A method of rejuvenating a deactivated molecular sieve catalyst, deactivated by use in an olefin oligomerization or aromatics alkylation process, which method comprises contacting the deactivated catalyst with a stream of rejuvenation gas comprising a hydrocarbon product fraction from the process at an elevated temperature and pressure for a time sufficient to effect an increase in catalytic activity of the deactivated catalyst.

2. A method according to claim 1 in which the contact between the deactivated catalyst and the rejuvenating gas stream is carried out at a pressure from 1000 to 8,000 kPag and at a temperature from 50 to 310° C.

3. A method according to claim 2 in which the contact between the deactivated catalyst and the rejuvenating gas stream is carried out at a pressure from 3,500 to 8,000 kPag and at a temperature from 100 to 230° C.

4. A method according to claims 1 in which the contact between the deactivated catalyst and the rejuvenating gas stream is carried out at a space velocity for the rejuvenating stream of from 0.1 to 7 hr⁻¹ LHSV.

5. A method according to claim 4 in which the contact between the deactivated catalyst and the rejuvenating gas stream is carried out at a space velocity for the rejuvenating stream of from 1 to 3 hr⁻¹ LHSV.

6. A method according to claim 1 in which the rejuvenating gas stream comprises a stream of a light product fraction (C1 to C8) obtained from a product fractionator for the process.

7. A method according to claim 1 in which the rejuvenating gas stream comprises a stream of a light alkylaromatic product fraction (C6 to C10) obtained from a product fractionator for the process.

8. A method according to claim 1 in which the catalyst is a porous solid molecular sieve catalyst deactivated by use in an olefin polymerization process using a light olefinic feed comprising C2 to C4 olefins.

9. A method according to claim 8 in which the catalyst comprises a zeolite of the MWW family.

10. A method according to claim 9 in which the catalyst comprises zeolite MCM-22 or zeolite MCM-49.

11. A process for the production of a gasoline boiling range hydrocarbon product by the oligomerization of a light petroleum refinery olefinic stream comprising C2 to C4 olefins in the presence of a solid, porous, molecular sieve catalyst until the catalyst is deactivated and then rejuvenating the catalyst by contacting the deactivated catalyst with a stream of rejuvenation gas comprising a C3 to C8 hydrocarbon product fraction from the process at an elevated temperature and pressure for a time sufficient to effect an increase in catalytic activity of the deactivated catalyst.

12. A method according to claim 11 in which the contact between the deactivated catalyst and the rejuvenating gas stream is carried out at a pressure from 3,500 to 8,000 kPag and at a temperature from 50 to 230° C.

13. A method according to claim 12 in which the contact between the deactivated catalyst and the rejuvenating gas stream is carried out at a space velocity for the rejuvenating stream of from 1 to 3 hr⁻¹ LHSV.

14. A method according to claim 11 in which the rejuvenating gas stream comprises a stream of a light hydrocarbon product fraction (C1 to C8) obtained from a product fractionator for the process.

15. A method according to claim 14 in which the catalyst comprises zeolite MCM-22 or zeolite MCM-49.

16. A process for the production of a gasoline boiling range hydrocarbon product by the alkylation of an aromatic refinery reformate stream containing benzene with a light refinery stream comprising C2 to C4 olefins in the presence of a solid, porous, molecular sieve catalyst until the catalyst is deactivated and then rejuvenating the catalyst by contacting the deactivated catalyst with a stream of rejuvenation gas comprising a C6 to C10 alkylaromatic hydrocarbon product fraction from the process at an elevated temperature and pressure for a time sufficient to effect an increase in catalytic activity of the deactivated catalyst.

17. A method according to claim 16 in which the contact between the deactivated catalyst and the rejuvenating gas stream is carried out at a pressure from 3,500 to 8,000 kPag and at a temperature from 50 to 230° C.

18. A method according to claim 16 in which the contact between the deactivated catalyst and the rejuvenating gas stream is carried out at a space velocity for the rejuvenating stream of from 1 to 3 hr⁻¹ LHSV.

19. A method according to claim 16 in which the rejuvenating gas stream comprises a stream of a light alkylaromatic product fraction (C6 to C8) obtained from a product fractionator for the process.

20. A method according to claim 16 in which the catalyst comprises zeolite MCM-22 or zeolite MCM-49.
